(19) United States
(12) Patent Application Publication
(10) Pub. No.: US 2016/0032747 A1
(43) Pub. Date: Feb. 4, 2016

(54) SEALING ELEMENT FOR SEALING GAP

(71) Applicant: SIEMENS AKTIENGESELLSCHAFT, München (DE)

(72) Inventors: Simon Bez, Heidelberg (DE); Ningsih Flohr, Mulheim an der Ruhr (DE); Vera Kristin Franke, Essen (DE); Pascal Hinkerohe, Oberkirch (DE); Frederic Etienne Kracht, Mulheim an der Ruhr (DE); Philipp Kreutzer, Haltern am See (DE); Rudolf Kuperkoch, Essen (DE); Florian Migas, Mulheim an der Ruhr (DE); Frank Preuten, Voerde (DE); Oliver Schneider, Wesel (DE); Hans Thermann, Dusseldorf (DE)

(73) Assignee: Siemens Aktiengesellschaft, Munich (DE)

(21) Appl. No.: 14/776,766

(22) PCT Filed: Mar. 12, 2014
(86) PCT No.: PCT/EP2014/054864

§ 371 Date: Sep. 15, 2015

(30) Foreign Application Priority Data
Mar. 21, 2013 (DE) 10 2013 205 028.3

(51) Int. Cl. F01D 11/00; F01D 25/12; F01D 25/24

(52) U.S. Cl. CPC F01D 11/005; F01D 25/24; F01D 25/12; F05D 2240/55; F05D 2220/32

(57) ABSTRACT

A sealing element for sealing a gap between two components, which can thermally move relative to each other and each have two substantially parallel component grooves, wherein the sealing element is directed along a main line and has, in a cross section substantially perpendicular to the main line, a first and second end segment and a middle region arranged between the end segments, to ensure an effective seal in the event of thermal expansions of the components that are comparatively large radially and to reduce thermal stresses and crack formations on the components. A third end segment having substantially the same extension direction as the first end segment is arranged on the middle region in parallel with the first end segment and a fourth end segment having substantially the same extension direction as the second end segment is arranged on the middle region in parallel with the second end segment.

### CROSS REFERENCE TO RELATED APPLICATIONS

This application is the US National Stage of International Application No. PCT/EP2014/054864 filed Mar 12, 2014, and claims the benefit thereof. The International Application claims the benefit of German Application No. DE 102013205028.3 filed Mar. 21, 2013. All of the applications are incorporated by reference herein in their entirety.

### FIELD OF INVENTION

The invention relates to a sealing element for sealing a gap between two components which can move thermally with respect to one another and which each have two essentially parallel component slots, wherein the sealing element is oriented along a main line and has, in a cross-section essentially perpendicular to the main line, a first end section and a second end section, and a central region arranged between the end sections. It further relates to a gas turbine with such a sealing element.

### BACKGROUND OF INVENTION

A gas turbine is a turbomachine in which a pressurized gas is expanded. It includes a turbine or expander, and upstream compressor and a combustion chamber connected between these. The operating principle is based on the cyclic process (Joule process): This uses the blading of one or more compressor stages to compress air, then mixes this air in the combustion chamber with a gaseous or liquid fuel and ignites and combusts it. In addition, the air is fed into a secondary air system and is used for cooling in particular components subjected to high thermal load.

This produces a hot gas (mixture of combustion gas and air) which expands in the downstream turbine part, wherein thermal energy is converted into mechanical energy and first drives the compressor. The remaining portion is used in a turboshaft engine for driving a generator, a propeller or other rotating consumers. In a jet engine, by contrast, the thermal energy accelerates the hot gas stream, which produces the thrust.

In the case of gas turbines with high turbine inlet temperatures of in some cases greater than 1000° C., the large temperature difference between cold start and operation causes thermal expansion of the individual components of the gas turbine, such that, in order to avoid high thermal stresses and crack formation, adjacent components are partially spaced apart from one another by a gap. Since the secondary air system is typically at a higher pressure than the hot gas duct, internal leaks of cold air into the turbine occur at the gaps and cause reductions in power and efficiency. This occurs in particular at gaps between platforms of turbine guide vanes and ring segments which bound the hot gas duct.

The leaks lead to increased energy consumption by the compressor and to more difficult configuration calculations for the components. A further reason for avoiding leaks relates to the real hot gas temperatures in the turbine: the more leak losses, the higher the air consumption of the secondary air system and thus less compressed air is fed to the combustion chamber. In order in this case to produce a high power of the turbine, the inlet temperature must be increased, by supplying more fuel. However, this increases the load on the components and additional cooling is required. The results of this are increased cost in terms of construction and reduced turbine efficiency.

In order to minimize the leaks, a wide variety of sealing concepts are used within the turbine, depending on the requirements. Commonly, flat sealing elements, which extend in a main line along the respective gap, e.g. along the circumferential direction in the case of radial gaps, are pushed into a slot which is generally perpendicular to or at a defined angle to gap to be sealed.

In the simplest case, the sealing elements are configured as flat sealing elements with a smooth surface. Also frequently used are corrugated or toothed sealing plates which are also termed riffle seal or comb-profiled seal.

This is a metal seal which has, between two ends or end sections, a central region with a smooth and a corrugated or toothed surface and is known for example from EP 0 852 659 B1. The toothed profile is deformed during assembly such that after installation their results and almost play-free connection between the components provided with a slot and the sealing element.

However, the above-mentioned sealing elements have the disadvantage that they are not suitable for components which are subjected to relatively large radial displacements with respect to one another, on account of their lack of flexibility in the radial direction. The relatively high stiffness of the plate rapidly leads to signs of wear by warpage and misalignment movements during operation of the gas turbine, which lead to leaks. In addition, the flexibility of the riffle tips is often low, such that correct installation of the plate is relatively difficult. In certain cases, it is even necessary to perform additional machining during assembly which can however also rapidly lead to undesired additional leaks.

### SUMMARY OF INVENTION

The invention therefore has an object of indicating a sealing element of the type mentioned in the introduction, which ensures an effective seal even during relatively large radial thermal expansions of the components and nonetheless reduces thermal stresses and crack formation in the components.

This object is achieved according to aspects of the invention in that there is arranged at the central region, parallel to the first end section, a third end section with essentially the same direction of extent as the first end section and, parallel to the second end section, a fourth end section with essentially the same direction of extent as the second end section.

In that context, the invention proceeds from the consideration that the sealing elements used hitherto primarily permit movement of the components along their direction of extent, typically in the axial direction. Greater flexibility of the sealing elements could be achieved if the plate thicknesses of the sealing elements were chosen to be smaller, such that the sealing element itself were able to move in a flexible manner. In that context, however, the hold of the sealing elements on the respective component should be improved. This is possible by arranging further end sections which are arranged parallel to the existing end sections. This results, on each side of the sealing element, in a double slot-spring connection with double, parallel slots in the component, such that the hold on the respective component is strengthened and the sealing action is improved.

In a first advantageous configuration, the central region comprises a section connecting the first and the third end sections and a section connecting the second and the fourth end sections, wherein the sections are connected via a connection section. In this context, therefore, the end sections inserted into parallel slots in the same component are directly connected to one another, e.g. by means of a semicircular section. The end sections are thus positioned as tips of a U-shaped section in the respective slots. The two sections are then further connected by means of a connection section which can extend e.g. straight through the gap. Other shapes are possible.

In a second, alternative or additional advantageous configuration, the central region comprises a section connecting the first and the second end sections and a section connecting the third and the fourth end sections, wherein the sections are connected via a connection section. In this context, therefore, two end sections introduced into component slots of different components, which are opposite one another across the gap, are connected to one another, e.g. in the manner of hitherto common sealing plates, which may however be made thinner in order to improve the elasticity for warpage and misalignment. The two connecting sections are then fixed to one another by means of a connection section. The sections can be e.g. directly welded or soldered to one another, such that the connection section consists only of the weld seam.

In an advantageous configuration, the connection section is self-restoringly extensible. This can for example be brought about by the connecting sections being connected by means of a spring or a strain bar. This further increases the elasticity of sealing element while the sealing element remains easy to install. The sealing effect even in the case of warpage and misalignment of the sealing element is thereby improved.

In a further advantageous configuration, the central region and/or the respective end sections are configured such that the respective end sections can be moved in a self-restoring manner with respect to one another in the same direction of extent. This can occur in a particularly simple manner in that the central region is made from an appropriately thin plate such that the elasticities of the material used permits a corresponding extension and compression. This also increases the elasticity of the sealing element.

In an alternative or additional advantageous configuration, the respective end section is of zigzag-shaped cross section. Together with the configuration of the sealing element, which is thinner in comparison with the sealing plates used hitherto, there thus results a resilient function in the axial direction. The zigzag shape of the end section causes the formation, depending on the axial prestress and misalignment and/or warpage of the components to be sealed, of multiple contact surfaces with the component slot.

In a further alternative or additional advantageous configuration, the respective end section has a toothed surface. Also when the sealing element is configured with a double slot-spring connection on each side, such a toothing in the manner of the riffle plates used hitherto is of substantial advantage: The toothing can be provided with an inclined portion which faces the central region such that the end region is on one hand compressible and on the other hand fixed in the slot in the manner of a barb. The toothing can also be applied on both sides of each end section in order to further improve the fixing in the slot.

Furthermore, the respective end section can advantageously be bent in the shape of a circle. When the end section is compressed, for example when it is pushed into the component slot, the radius is reduced, the end section is compressed and slides smoothly into the slot. In the event of an outward movement, however, the element braces itself and thus prevents removal.

Advantageously, the sealing element is made at least in part from a metallic material. In particular, metallic materials offer reversible deformability while being sufficiently thin, such that the advantages of the above-described geometric configurations can be improved or even made possible in the first place.

A sealing element as described is arranged, in an advantageous configuration, in a gas turbine which has a hot gas region and—to be sealed with respect to the latter—a cold gas region for cooling guide vanes of the gas turbine, wherein the sealing element engages in two essentially parallel component slots of the first component and in two essentially parallel component slots of a second component adjoining the first component, wherein a gap is formed between the components. The double slot-spring connection in each component provides a particularly secure hold of the sealing element even in the event of marked displacement or warpage, such that the cool gas region is well sealed with respect to the hot gas region.

In this context, the end section to be inserted into the respective component slot is advantageously slightly larger than the respective component slot. This means that the end section is deformed already at the insertion stage without a thermal expansion already having taken place. This effectively seals the gap independently of the current temperature in the gas turbine and the temperature difference between the cold gas region and the hot gas-guiding region.

In a further advantageous configuration, the component slot in which the sealing element engages narrows from the gap inward into the component. This simplifies installation since the sealing element can be more easily inserted into the component slot. The narrowing can in particular be formed such that the web formed between the parallel component slots can be configured so as to have a wedge-shaped profile.

In another further advantageous configuration, the separation between those end sections that engage in the essentially parallel component slots is slightly smaller than the separation between the essentially parallel component slots. This means that, upon insertion into the slot, the end sections are pressed apart from one another such that the prestress thus created holds the sealing element in the slots in the manner of a claw. In particular in combination with the end sections being bent in the shape of a circle, in particular when they are bent inward, i.e. toward the respective other end section, the sealing element is fixed in the slots particularly well. Prestressing the end sections against one another means that pulling out the sealing element results in a rolling movement, in particular at the end sections, whereby the radius of the circular bend is increased and the end section wedges itself in the respective slot.

Advantageously, the length of the respective end section varies along the main line and the respective end section engages in a component slot whose depth profile is adapted to the variation in the length. It is thus possible, in a simple manner, to secure the sealing element against displacement along the main line: variable-depth component slots and accordingly adapted expansion of the end sections make it possible for the sealing element to be secured in a form-fitting manner against displacement along the main line. In addition, it is possible in this manner for sealing elements and component slots to be matched in the manner of a coding, such that a certain sealing element fits only in a certain component slot on account of its length variation along its main line. This can prevent mistakes during installation.

A gas turbine with a hot gas region and—to be sealed with respect to the latter—a cold gas region for cooling guide vanes, wherein the regions are separated from one another by a multiplicity of components arranged in the circumferential direction and in the axial direction, and at least one first component and one second component are spaced apart by a gap, advantageously has two essentially parallel component slots in the first component and two essentially parallel component slots in the second component, in which there is arranged a sealing element as described, so as to seal the gap.

The advantages achieved with the invention are in particular that a sealing element with on both sides double parallel end sections, which are introduced into corresponding double component slots on each side of the gap, permits a substantially better hold of the sealing element and greater flexibility in the radial direction when sealing two axially separated components in a gas turbine. The flexibility of the sealing element thus minimizes thermal stresses and prevents crack formation. In addition, reliable closing of the gap achieves an improved sealing effect. The high potential for equalizing axial play and the self-limiting effect also reduce the current risk of the sealing element falling out of the component slot.

### BRIEF DESCRIPTION OF THE DRAWINGS

The invention is explained in more detail with reference to multiple exemplary embodiments represented in the drawing, in which:

FIG. 1 shows a detail from a longitudinal section through a gas turbine,

FIGS. 2 to 10 show cross sections through various sealing elements in the gas turbine, and

FIG. 11 shows a plan view of the sealing element from FIG. 10.

### DETAILED DESCRIPTION OF INVENTION

In all figures, the same parts have been provided with the same reference signs.

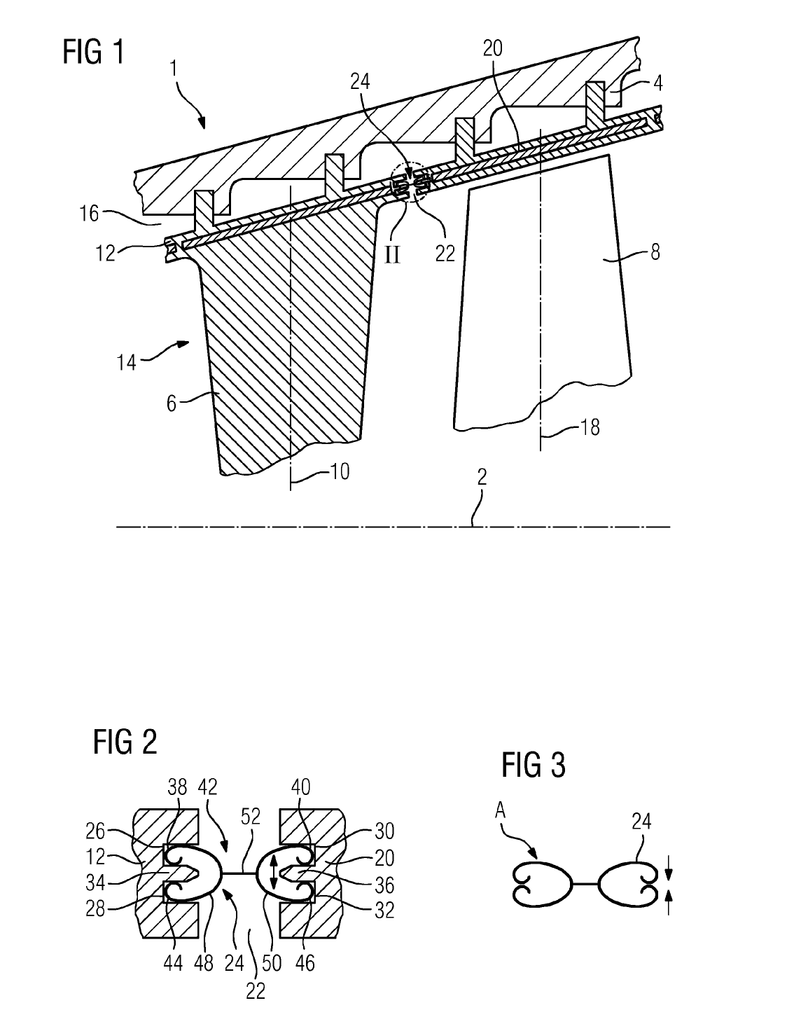

FIG. 1 shows a detail of a gas turbine 1 which is oriented along an axis 2. In the following, terms such as axial, radial or in the circumferential direction always relate to the axis 2 of the gas turbine 1.

The gas turbine 1 has, in a casing 4 and in alternation in the axial direction, guide vanes 6 and rotor blades 8. The guide vanes 6 are oriented along an axis 10 perpendicular to the axis 2 of the gas turbine, and are arranged along the circumference of the gas turbine 1 so as to form a circle. Such a circle of guide vanes 6 is also termed a guide vane disk. The guide vanes 6 are connected to the casing 4 of the gas turbine 1 by means of a respective guide vane plate 12 and are thus part of the stator of the gas turbine 1.

Along the circumference, adjacent guide vanes 6 are spaced apart from one another by a respective gap (not shown in more detail), which leaves these largely free to expand thermally. The guide vane plate 12 separates a hot gas region 14, formed around the axis 2 of the gas turbine 1, from a cool gas region 16 formed between the guide vane plate 12 and the casing 4. In the hot gas region 14, there flows the hot gas combusted upstream in the combustion chamber (not shown), while in the cold air region there typically flows bleed air from the end region of the compressor.

The rotor blades 8 extend along a respective axis 18 which is also essentially orthogonal to the axis 2 of the gas turbine 1. The rotor blades 8 are entirely within the hot gas region 14. They are arranged in the manner of a ring as a rotor blade disk on the rotor of the turbine, so as to rotate about the axis 2. A guide vane disk, together with the downstream rotor blade disk, is termed a turbine stage.

In the region of the rotor blades 8, the hot gas region 14 is separated from the cold gas region 16 by a multiplicity of ring segments 20 along the circumference of the gas turbine 1. The ring segments 20 are in this case respectively connected to the casing 4. For the sake of clarity, in each case only one guide vane 6, one rotor blade 8 and one ring segment 20 are represented.

In the axial direction, a respective ring segment 20 is spaced apart from a respective guide vane 6, in particular from the guide vane plate 12, by a gap 22. This gap 22 is sealed by means of a sealing element 24, which essentially prevents a flow of cold gas from the cold gas region 16 into the hot gas region 14.

In this context, the guide vane 12 represents a first component and the ring segment 20 represents a second component. In the axial direction, the cold gas region 16 is thus sealed with respect to the hot gas region 14 between adjacent guide vanes 6 and ring segments 20 and, in the circumferential direction, there is in each case a seal between adjacent guide vanes 12 and correspondingly between adjacent ring segments 20.

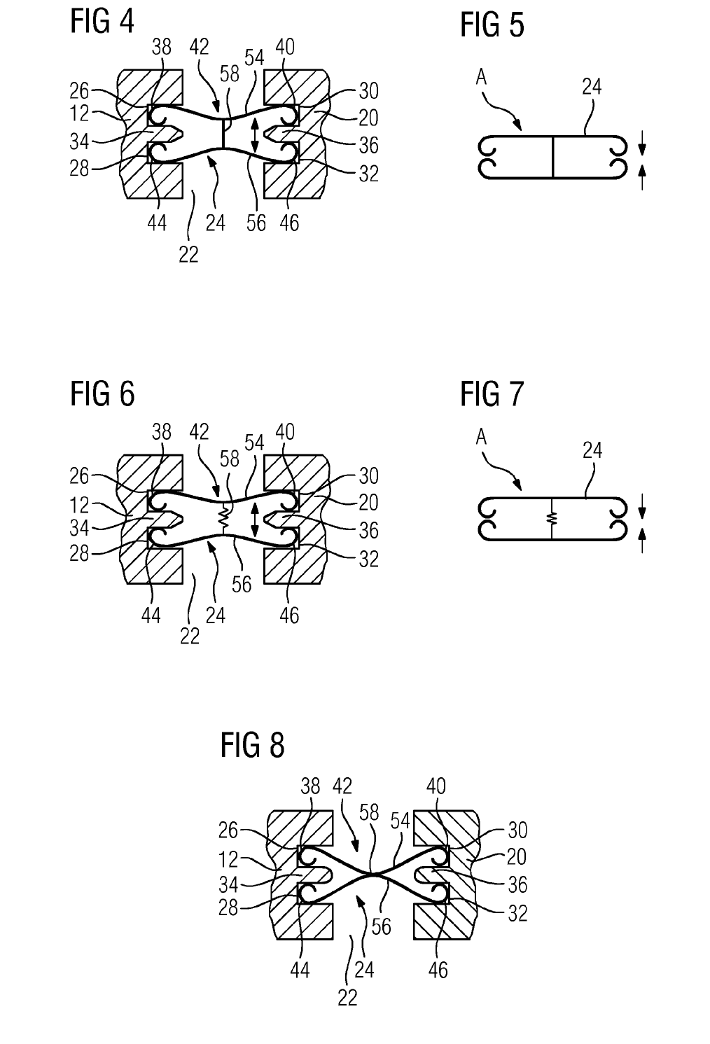

FIG. 2 shows a first exemplary embodiment for the sealing element 24 in the enlarged representation of the region II from FIG. 1. FIG. 2 shows a guide vane plate 12 and a ring segment 20 as two adjacent components which are spaced apart from one another by the gap 22. Alternatively, the components can be two adjacent guide vanes 6, in particular guide vane plates 12, or two adjacent ring segments 20.

Two circumferentially parallel component slots 26, 28 or, respectively, 30, 32 are introduced into each of the components 12, 20. The component slots 26, 28 in the guide vane plate 12 are in that context oriented toward the ring segment 20; the component slots 30, 32 in the ring segment 20 are oriented toward the guide vane plate 12. The component slots 26, 28 in the guide vane plate 12 are separated from one another by a web 34; the component slots 30, 32 in the ring segment 20 are separated from one another by a web 36. The webs 34, 36 taper toward the gap 22 in the shape of a wedge, such that the slots 26, 28, 30, 32 widened toward the gap 22.

A sealing element 24 engages in the component slots 26, 28, 30, 32 so as to seal the gap 22. The sealing element 24 is oriented along a circumferentially oriented main line leading into the drawing, and has, in the represented cross section perpendicular to the main line, a first end section 38, a second end section 40 and, therebetween, a central region 42. The first end section 38 is in the component slot 26 and is thus oriented essentially in the radial direction toward the guide vane plate 12. The second end section 40 is in the component slot 30 and is thus oriented essentially in the radial direction toward the ring segment 20.

Arranged parallel to the first end section 38 at the central region 42, there is a third end section 44 in the component slot 28. Arranged parallel to the second end section 40 at the central region 42, there is a fourth end section 46 in the component slot 32. The end sections 38, 44 in the component slots 26, 28 of the guide vane carrier 12 are connected by a parabolic section 48. In the same way, the end sections 40, 46 in the component slots 30, 32 of the ring segment 20 are connected by a parabolic section 50. The sections 48, 50 are connected by a radially oriented connection section 52.

The end sections 38, 40, 44, 46 are each bent inward, i.e. toward the respective other end section 38, 40, 44, 46 in the same component 12, 20, in a circular shape. This results, in cross section, in a bend around approximately three quarters of a circle. The entire sealing element 24 is made of relatively thin sheet metal, for example a nickel alloy having high thermal stability. The sealing element 24 is thus elastically extensible. This elasticity is used for fixing the sealing element 24 in the component slots 26, 28, 30, 32.

The axial separation between the respective parallel end sections 38, 44 or, respectively, 40, 46 is namely, in the not-installed state of the sealing element 24, greater than the separation between the parallel component slots 26, 28 or, respectively, 30, 32. This can be seen in the comparative drawing shown in FIG. 3, which shows the sealing element 24 in the not-installed state. Furthermore the respective end section 38, 40, 44, 46 with its circular bend is slightly larger than the respective component slot 26, 28, 30, 32.

When inserted into the component slots 26, 28, 30, 32, the end sections 38, 40, 44, 46 are compressed and mutually parallel end sections 38, 44 or, respectively, 40, 46 are pressed apart from one another. The wedge shape of the webs 34, 36 permits simple insertion. The return force due to the material elasticity thus causes the sealing element 24 to be fixed on the components 12, 20. The overall bent shape of the sealing element 24 as a whole acts as a spring in the event of geometric changes in the gap 22.

FIGS. 4 to 10 show in each case alternative exemplary embodiments of the sealing element 24. The drawings are described with reference to their differences with respect to the exemplary embodiment of FIG. 2, or other above-described figures. Features not mentioned are essentially identical to FIG. 2 or to the above-described figure mentioned in each case.

FIG. 4 shows a sealing element 24 whose central region 42 is of a different configuration with respect to FIG. 2: in this case, opposing end sections 38, 40 or 44, 46 (in each case with respect to the gap 22) are connected to one another by essentially axially oriented connecting sections 54 or 56. The sections 54, 56 are connected by a radially oriented connection section 58. The connection section 58 can extend over the entire length of the sealing element 24 along the main line or be interrupted such that only a section-wise or punctual connection exists.

By virtue of the separation between the respective end sections 38, 44 or 40, 46 being larger than the separations between the component slots 26, 28 or 30, 32, the sections 54, 56 are bent toward the central point of the central region 42 in the installed state (see the comparative drawing FIG. 5).

FIG. 6 shows, in essence, the sealing element 24 from FIG. 4, wherein the connection section 58 is configured as a resilient element, i.e. as an arrangement of springs or strain bars, in order to increase flexibility.

FIG. 8 also shows, in essence, the sealing element 24 from FIG. 4, wherein the connection section 58 now consists only of a weld seam between the sections 54, 56 which are connected to one another. Accordingly, the sections 54, 56 are more bent. The webs 34, 36 are not wedge-shaped but are rounded. FIG. 6 also shows a situation in the event of an axial increase of the gap: the curved end sections 38, 40, 44, 46 roll as a consequence of the force ratios and wedge themselves in the component slots 26, 28, 30, 32.

The sealing element 24 represented in FIG. 9 is made of thicker sheet material than the sealing element 24 of FIG. 2. Accordingly, no curved sections are provided, rather opposing end sections 38, 40 or 44, 46 (in each case with respect to the gap 22) are connected to one another by essentially axially oriented, relatively rigid connecting sections 54 or 56. The sections 54, 56 are connected by means of the connection section 58 which essentially consists of a weld seam. Alternatively, the sections 54, 56 can be connected by brazing. Here, too, the connection section 58 can extend over the entire length of the sealing element 24 along the main line or be interrupted such that only a section-wise or punctual connection exists.

The end sections 38, 40, 44, 46 are zigzag-shaped and are slightly larger than the respective component slot 26, 28, 30, 32. They are thus compressed upon insertion into the component slots 26, 28, 30, 32 and form, depending on the axial prestress and misalignment or warpage of the components to be sealed, multiple contact surfaces with the component slot 26, 28, 30, 32.

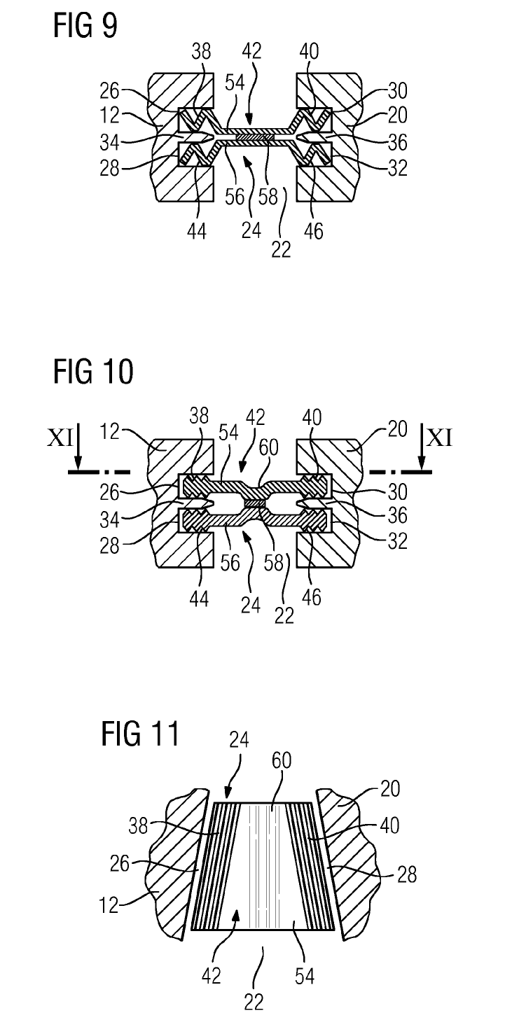

In a further exemplary embodiment, shown in FIGS. 10 and 11, the sheet material is also thicker than in the exemplary embodiment of FIG. 4, but still thinner than in the case of the sealing plates used hitherto. In this case too, opposing end sections 38, 40 or 44, 46 (in each case with respect to the gap 22) are connected to one another by essentially axially oriented connecting sections 54 or 56. The sections 54 and 56 have at their centre a convexity 60 which is oriented toward the respective other section 54 or 56. At the convexities 60, the sections 54, 56 are connected by means of the connection section 58 which also essentially consists of a weld seam.

The end sections 38, 40, 44, 46 are toothed on their radially oriented surfaces, i.e. both those surfaces oriented toward the hot gas region 14 and those oriented toward the cold gas region 16. The toothing represented schematically can in that context be inclined in the direction of the central region 42 such that, in conjunction with the fact of being a larger than the respective component slot 26, 28, 30, 32, a barb-like effect is achieved

In FIGS. 4 to 10, the end sections 38, 40 adjoining the cold gas region 16 form, together with the connecting section 54, one sheet; the end sections 44, 46 adjoining the hot gas region form, together with the connecting section 56, a further sheet. The sheets are connected at the connection section 58 to give the finished sealing element 24. In all of these exemplary embodiments, it is possible to vary the length of the end sections 38, 40, 44, 46 in conjunction with the slot depth of the component slots 26, 28, 30, 32 along the main line. This is shown in the example of the exemplary embodiment of FIG. 10.

FIG. 11 shows the view XI from FIG. 10, showing only the sheet oriented toward the cold gas region 16. The end sections 38, 40 vary in length linearly along the mainline, such that a trapezoidal shape of the sheet results. The component slots 26, 30 are matched to the length variation.

That sheet oriented toward the hot gas region 14 (not shown) has the same length variation but is arranged in reverse with respect to the main line, such that the trapezoidal shape opposes that of the first sheet. The component slots 28, 32 are matched accordingly. This secures the sealing element 24 against displacement along the main line.

In all of the exemplary embodiments of FIGS. 4 to 11, that sheet which is oriented toward the cold gas region 16 can be made of a less heat-resistant and thus more cost-effective material than the sheet oriented towards the hot gas region 14. In order to simplify installation, the component slots 26, 28, 30, 32 can taper inward into the respective component 12, 20.

1. A sealing element for sealing a gap between two components which can move thermally with respect to one another and which each have two essentially parallel component slots, wherein the sealing element is oriented along a main line and comprises,
in a cross-section essentially perpendicular to the main line, a first end section and a second end section, and a central region arranged between the end sections,
a third end section wherein there is arranged at the central region, parallel to the first end section, wherein the third end section has essentially the same direction of extent as the first end section and,
a fourth end section parallel to the second end section, wherein the fourth end section has essentially the same direction of extent as the second end section.

2. The sealing element as claimed in claim 1,
wherein the central region comprises a section connecting the first and the third end sections and a section connecting the second and the fourth end sections,
wherein the sections are connected via a connection section.

3. The sealing element as claimed in claim 1,
wherein in which the central region comprises a section connecting the first and the second end sections and a section connecting the third and the fourth end sections,
wherein the sections are connected via a connection section.

4. The sealing element as claimed in claim 3,
wherein the connection section is self-restoringly extensible.

5. The sealing element as claimed in claim 1,
wherein the central region and/or the respective end sections are configured such that the respective end sections can be moved in a self-restoring manner with respect to one another in the same direction of extent.

6. The sealing element as claimed in claim 1,
wherein the respective end section is zigzag-shaped.

7. The sealing element as claimed in claim 1,
wherein in which the respective end section has a toothed surface.

8. The sealing element as claimed in claim 1,
wherein in which the respective end section is bent in the shape of a circle.

9. The sealing element as claimed in claim 1,
comprising at least in part a metallic material.

10. The sealing element as claimed in claim 1, in a gas turbine with a hot gas region and, to be sealed with respect to the latter, a cold gas region for cooling guide vanes of the gas turbine,
which engages in two essentially parallel component slots of the first component and in two essentially parallel component slots of a second component adjoining the first component,
wherein a gap is formed between the components.

11. The sealing element as claimed in claim 10,
wherein the end section to be inserted into the respective component slot is slightly larger than the respective component slot.

12. The sealing element as claimed in claim 10,
wherein the sealing element engages in a component slot that narrows away from the gap into the component.

13. The sealing element as claimed in claim 10,
wherein the separation between those end sections that engage in the essentially parallel component slots is slightly smaller than the separation between the essentially parallel component slots.

14. The sealing element as claimed in claim 10,
wherein the length of the respective end section varies along the main line and the respective end section engages in a component slot whose depth profile is matched to the variation in the length.

15. A gas turbine comprising
a hot gas region and, to be sealed with respect to the latter, a cold gas region for cooling guide vanes,
wherein the regions are separated from one another by a multiplicity of components arranged in the circumferential direction and in the axial direction, and
at least one first component and one second component are spaced apart by a gap and the first component and the second component have two essentially parallel component slots in which there is arranged a sealing element as claimed in claim 1, so as to seal the gap.
